(19) United States
(12) Patent Application Publication
(10) Pub. No.: US 2010/0151980 A1
(43) Pub. Date: Jun. 17, 2010

(54) FLYWHEEL DRIVE CONTROL ARRANGEMENT

(76) Inventors: Timothy James Bowman, Bexley (GB); Robert Colin Helle-Lorentzen, Chelmsford (GB); Donatus Andreas Josephine Kees, Billericay (GB)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 12/637,976

(22) Filed: Dec. 15, 2009

(30) Foreign Application Priority Data
Dec. 16, 2008 (GB) 0822862.9

(51) Int. Cl. F16H 48/06

(52) U.S. Cl. 475/149

(57) ABSTRACT

In an energy storage and recovery system suitable for a hybrid vehicle 1 and incorporating a flywheel 9, parasitic losses are minimised, thereby permitting a rotating flywheel to retain energy for a longer period of time. The flywheel is driven via an epicyclic gearset 13. An electro-hydraulic clutch 14 serves to decouple the annulus gear 21 so that it does not transmit any torque under certain vehicle operating conditions.

### BACKGROUND OF THE INVENTION

This invention relates to a flywheel drive control arrangement, suitable for use as part of an energy storage and recovery system such as may be incorporated in a hybrid vehicle.

In a high-speed flywheel-based energy storage and recovery system, the flywheel is connected to the transmission of the vehicle via a continuously variable transmission (C. V. T.) and manipulation of the C. V. T. ratio achieves control of energy storage and recovery. See, for example, SAE technical paper 2008-01-0083, Apr. 14-17, 2008.

Typically, the flywheel rotates at over 50,000 rpm and an epicyclic and spur gear is used to reduce this speed to a level acceptable as an input speed into the C. V. T. When the ratio is changed so as to speed up the flywheel, energy is stored and when the ratio is changed so as to slow down the flywheel, energy is recovered. However, whenever power flow into the flywheel is stopped, the rotational speed of the flywheel gradually decays due to internal friction and aerodynamic losses through continuing to drive the step-down gears. This decay represents wastage of the energy contained within the flywheel as this dissipated energy is not recoverable. If the vehicle is stopped for long period of time, such as over a weekend, the flywheel speed may decay to zero. Consequently, the entire flywheel's stored energy is dissipated and permanently lost.

Hence, it would be advantageous to minimise these frictional losses in the transmission components.

### SUMMARY OF THE INVENTION

According to the present invention, a flywheel drive control arrangement comprises;

a structure,
a flywheel mounted on a shaft and rotatable with respect to said structure,
an epicyclic gearset including a sun gear connected to an end of the shaft, a planet carrier gear for connection to an input/output shaft of a drivetrain and an annulus gear,
and a clutch, for connecting and disconnecting the annulus gear to and from the structure.

Conveniently, the structure may be a housing for containing the flywheel.

The drivetrain may include a continuously variable transmission. (CVT)

Preferably, the clutch is controlled electronically, to either fix or release the annulus to or from the structure

When the annulus is fixed (by the clutch) to the Structure, the epicyclic gearset can operate conventionally with a reduction ratio suitable for driving a CVT. Conversely, under conditions where power flow into the flywheel is stopped and it is anticipated that the stoppage will last a significant duration, the clutch is opened. Consequently, the annulus is released from the structure, is free to rotate and the parasitic losses acting on the flywheel are reduced. Hence the energy stored in the flywheel will be retained for a longer period of time.

### BRIEF DESCRIPTION OF THE DRAWINGS

An embodiment of the invention will now be described, by way of example only, with reference to the drawings of which;

FIG. 1 is a schematic diagram of a flywheel drive control arrangement in accordance with an embodiment of the invention, and

FIG. 2 is a schematic diagram of a vehicle incorporating the flywheel drive control arrangement of FIG. 1.

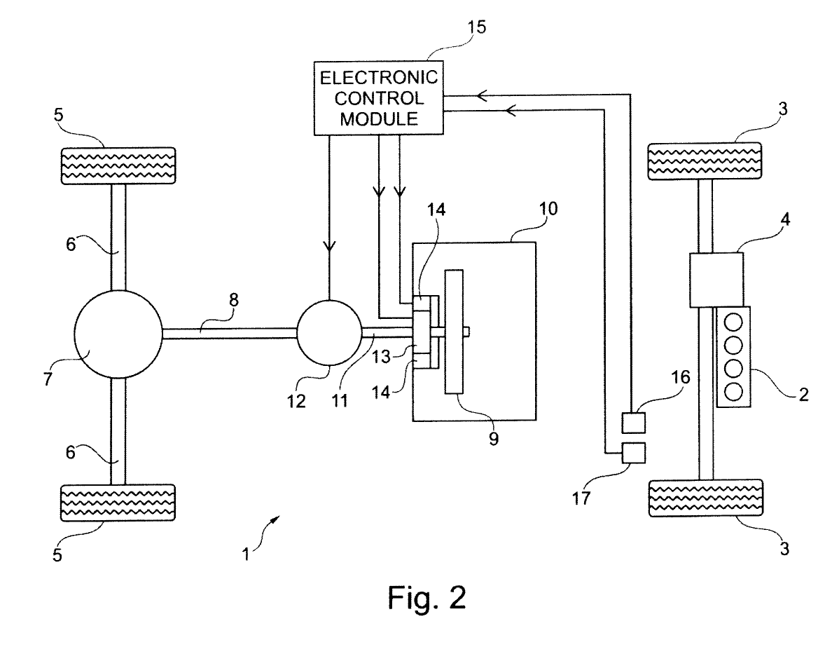

### DETAILED DESCRIPTION OF A PREFERRED EMBODIMENT

With reference to the figures, a vehicle 1 is equipped with an internal combustion engine 2 which provides a primary source of motive power to a first set of wheels 3 through a gearbox and final drive assembly 4.

A second set of wheels 5 is connected via half shafts 6 and a final drive and differential unit 7 to a propshaft 8. The propshaft 8 can drive and be driven by a flywheel 9. Thus the flywheel acts as an energy storage means and as a secondary source of motive power.

The flywheel 9 is contained within a housing 10 and is connected to a an input/output shaft 11 of a continuously variable transmission (CVT) 12 via an epicyclic gearset 13 and clutch 14.

An electronic control module 15 receives input signals from a brake pedal position sensor 16 and from an engine condition sensor 17, the latter detecting whether the engine is running or not. Output connections from the electronic control module (ECM) 15 are made to CVT 12 and clutch 14.

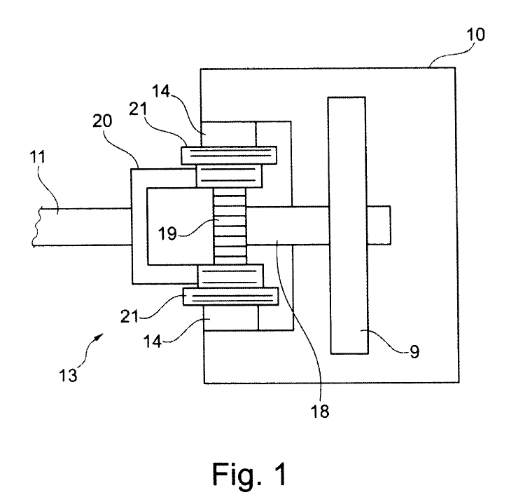

With particular reference to FIG. 1, the flywheel 9 is attached to a shaft 18, both of which may rotate together inside the housing 10. Conveniently the housing 10 is evacuated in order to minimise aerodynamic losses. A distal end of the shaft 18, which protrudes through an opening in the housing, is secured to a sun gear 19 of the epicyclic gearset 13.

A planet carrier gear 20 of the epicyclic gearset 13 is secured to the input/output shaft 11 of the CVT 12.

An annulus gear 21 of the epicyclic gearset 13 can be connected to and disconnected from the housing 10 by means of the clutch 14.

The CVT 12 can be of conventional design whose ratio can be varied in a known manner by operation of solenoid valves (not shown) which control an oil flow to the CVT. Activation of the valves is under the control of the ECM 15. Oil pressure is conventionally maintained by a pump (not shown) which may, conveniently, be driven by the propshaft 8.

The ECM 15 calculates the CVT ratio required to either accelerate the flywheel 9, (in order to store energy) or decelerate the flywheel 9 (in order to release energy and so drive the vehicle).

The ECM 15 also generates a control signal for the clutch 14 which in this example is an electro-hydraulic clutch.

Say, for example, that the driver of the vehicle 1 wishes to slow down. When he depresses the brake pedal, the sensor 16 sends a signal to the ECM 15. This is an appropriate time in the vehicle's driving cycle for energy to be transferred to the flywheel 9, otherwise it would be dissipated as heat in the brakes. (In an alternative arrangement, an accelerator pedal position sensor (not shown) is used to detect that the driver wishes to slow down, i.e., when the driver lifts his/her foot off the accelerator pedal.)

In response to the sensor's signal, the ECM 15 calculates and sets the CVT 12 at the optimum ratio for spinning up the flywheel 9. So with the clutch 14 closed, torque is transmitted by the epicyclic gearset 13 from the input/output shaft 11 of the CVT 12 to the flywheel 9.

When the engine has stopped running, this fact is relayed to the ECM 15 by the sensor 17. In response, the ECM15 sends a control signal to the clutch 14 causing it to open. Hence, the annulus gear is disconnected from the housing 10. The flywheel 9 and sun gear 19 will continue to rotate. The annulus 21 is free to spin but will not transmit any torque to the CVT 12.

We claim:

1. A flywheel drive control arrangement comprising;
a structure,
a flywheel mounted on a shaft and rotatable with respect to said structure,
an epicyclic gear set including a sungear connected to an end of the shaft, a planet carrier gear for connection to an input/output shaft of a drivetrain and an annulus gear,
and a clutch for connecting and disconnecting the annulus gear to and from the structure.

2. A flywheel drive control arrangement as claimed in claim 1 in which the structure is a housing containing the flywheel.

3. A flywheel drive control arrangement as claimed in claim 1 in which the drivetrain includes a continuously variable transmission.

4. A flywheel drive control arrangement as claimed in claim 1 in which the clutch is an electronically controllable clutch.
